(19) United States
(12) Patent Application Publication
(10) Pub. No.: US 2026/0225148 A1
(43) Pub. Date: Aug. 6, 2026

(54) WELDING-WIRE-STRAIGHTENING APPARATUS

(71) Applicant: Kabushiki Kaisha Kobe Seiko Sho (Kobe Steel, Ltd.), Kobe-shi (JP)

(72) Inventors: Kenta SUGIZAKI, Fujisawa-shi (JP); Yu UMEHARA, Fujisawa-shi (JP)

(73) Assignee: Kabushiki Kaisha Kobe Seiko Sho (Kobe Steel, Ltd.), Kobe-shi (JP)

(21) Appl. No.: 19/145,966

(22) PCT Filed: Feb. 14, 2024
(86) PCT No.: PCT/JP2024/005006

§ 371 Date: Jul. 7, 2025

(30) Foreign Application Priority Data
Mar. 27, 2023 (JP) 2023-050267

(51) Int. Cl. B21F 1/02; B21D 3/05; B23K 9/12

(52) U.S. Cl. CPC B21F 1/023; B21D 3/05; B23K 9/124

(57) ABSTRACT

In the present invention, n straightening rolls are positioned such that an inlet-side wire deformation parameter Cᵢₙ, which is calculated by a mathematical expression Cᵢₙ=Lᵢₙ/[{(δᵢₙ+t)/gᵢₙ}²], is 1,150-1,500, and an outlet-side wire deformation parameter Cₒᵤₜ, which is calculated by a mathematical expression Cₒᵤₜ=Lₒᵤₜ/[{(δₒᵤₜ+t)/gₒᵤₜ}²] is 4,300-49,000, and n straightening rolls are positioned such that a welding wire feed resistance parameter F, which is calculated by a mathematical expression F=(Lᵢₙ/Cᵢₙ+Lₒᵤₜ/Cₒᵤₜ)×n is less than 0.037.

### TECHNICAL FIELD

The present invention relates to a welding-wire-straightening apparatus.

### BACKGROUND ART

In metal welding such as arc welding, a welding wire fed to a welding torch is melted and consumed by arc heat. Therefore, the welding wire needs to be continuously fed to the welding torch according to the amount of consumption in the welding torch.

The welding wire is drawn out from a spool around which it is wound or a pack in which it is stored, and is fed to the welding torch, but the drawn welding wire is curled, and bent or twisted. When a curled welding wire is directly fed to the welding torch like this, the accuracy (hereinafter, referred to as a target property) of the target position of the wire end is reduced. Thus, conventionally, in order to obtain a favorable target property at the time of welding, a curled welding wire (hereinafter simply referred to as a wire) is straightened into a linear form by a welding-wire-straightening apparatus (hereinafter simply referred to as a straightening apparatus), then fed to the welding torch.

Such a straightening apparatus may be provided at a position immediately before the feeding device on the robot arm of a welding robot, in a position immediately after a welding wire is drawn out from a pack, or in a position between a pack and a feeding device installed in a welding robot. Note that if a straightening apparatus is installed immediately after a feeding device, the welding wire may buckle, which is not preferable.

When a wire is fed for a long distance after passing through a straightening apparatus, the wire undergoes deformation such as bending and twisting again, thus in order to improve the target property of the wire, it is preferable that the position where the wire is straightened be close to the arc spot. Therefore, it is more preferable that the straightening apparatus be provided immediately before the feeding device, for example, on the robot arm. In addition, the straightening apparatus is preferably small in size regardless of its installation position so that the straightening apparatus is unlikely to be restricted by the size and shape of the installation space. Particularly, when provided on the robot arm, the straightening apparatus is desirably small in size to avoid restrictions on the range of motion of the welding robot.

In the welding-wire-straightening apparatus described in PTL 1, as the diameter of a plurality of straightening rollers, a small value less than or equal to 20 mm is used, which has not been used in the conventional straightening apparatuses. The effect of miniaturizing the straightening apparatus is obtained by making the straightening rollers small in size.

### CITATION LIST

### Patent Literature

PTL 1: Japanese Patent No. 6109064

### SUMMARY OF INVENTION

### Technical Problem

Even when the straightening apparatus is miniaturized using small-diameter rollers with a diameter less than or equal to 20 mm as in PTL 1, the straightening apparatus interferes with a welding booth or a safety fence depending on the range of motion of the welding robot, thus the straightening apparatus may not be provided on the robot arm. Thus, further miniaturization of the straightening apparatus is desired.

Because the straightening apparatus plastically deforms the wire using a plurality of straightening rollers, the wire-feed resistance is likely to increase. When the feed resistance is too high, the feed resistance at the time of feeding the welding wire increases, thus the welding wire cannot be fed smoothly, which may result in poor welding. Therefore, the feed resistance of the straightening apparatus is desirably low. The welding-wire-feed resistance of the straightening apparatus can be lowered by reducing the displacement amount of plastic deformation of the welding wire by the straightening rollers. Meanwhile, when the displacement amount of plastic deformation of the welding wire is reduced to a certain level or lower, the straightening effect on the welding wire by the straightening apparatus is also reduced, thus the target property may deteriorate.

The present invention has been made in consideration of the above-mentioned problem, and it is an object of the invention to provide a welding-wire-straightening apparatus that can achieve improvement of the wire target property, reduction of the wire-feed resistance, and miniaturization of the straightening apparatus.

### Solution to Problem

The above object of the present invention is achieved by the configuration of [1] according to a welding-wire-straightening apparatus.
[1] A welding-wire-straightening apparatus for straightening bend of a welding wire, comprising two roller groups each including a plurality of straightening rollers, the welding wire being passed through the two roller groups,
wherein the plurality of straightening rollers included in each of the roller groups are arranged with a predetermined arrangement interval L in a passing direction of the welding wire so as to be opposed across a straightening path along which the welding wire is passed,
the two roller groups are arranged so that opposing directions across the straightening path are different,
in each of the roller groups, the plurality of straightening rollers are such that a first roller, a second roller, . . . , nth roller are sequentially disposed in the passing direction of the welding wire, bending deformation in opposite directions is alternately applied to the welding wire by these n rollers (n is an integer greater than or equal to 4) to straighten curl,
let t (mm) be a diameter of the welding wire,
let δᵢₙ (mm) be an entrance roller engaging amount caused by the first roller, the second roller and the third roller,
let 2Lᵢₙ (mm) be an interaxial distance between the first roller and the third roller,
let gᵢₙ (mm) be an entrance chord length which is a chord length of an overlapping portion of the second roller with the welding wire under an assumption that the welding wire is linearly arranged to come into contact with the first roller and the third roller,
let δₒᵤₜ (mm) be an exit roller engaging amount caused by the (n−2)th roller, the (n−1)th roller and the nth roller,
let 2Lₒᵤₜ (mm) be an interaxial distance between the nth roller and the (n−2)th roller,
let gₒᵤₜ (mm) be an exit chord length which is a chord length of an overlapping portion of the (n−1)th roller with the welding wire under an assumption that the welding wire is linearly arranged to come into contact with the (n−2)th roller and the nth roller, then
the n straightening rollers are positioned so that an entrance wire deformation parameter Cᵢₙ calculated by a mathematical expression Cᵢₙ=Lᵢₙ/[{(δᵢₙ+t)/gᵢₙ}²] is 1150 to 1500, and an exit wire deformation parameter Cₒᵤₜ calculated by a mathematical expression Cₒᵤₜ=Lₒᵤₜ/[{(Sout+t)/gₒᵤₜ}²] is 4300 to 49000, and
the n straightening rollers are positioned so that a welding-wire-feed resistance parameter F calculated by a mathematical expression F=(Lᵢₙ/Cᵢₙ+Lₒᵤₜ/Cₒᵤₜ)×n is less than 0.037.

### Advantageous Effects of Invention

According to the present invention, it is possible to provide a welding-wire-straightening apparatus that can achieve improvement of the wire target property, reduction of the wire-feed resistance, and miniaturization of the straightening apparatus.

### BRIEF DESCRIPTION OF DRAWINGS

FIG. 1 is a schematic view for schematically explaining a process of passing a welding wire through a welding-wire-straightening apparatus according to the present embodiment, and feeding the welding wire to a welding torch of a welding robot, the welding wire being drawn out from a pack.

FIG. 2A is a front view as seen from the front of the straightening apparatus.

FIG. 2B is a top view as seen from the top of the straightening apparatus.

FIG. 3A is a front view of a straightening roller.

FIG. 3B is a top view of the straightening roller.

FIG. 4 is a view as seen from the front of the straightening apparatus illustrated in FIG. 2A with a welding wire passed through the straightening apparatus.

FIG. 5 is an enlarged view illustrating a first roller group of straightening apparatuses with magnification.

FIG. 6 is a conceptual view conceptually illustrating a relationship between arrangement of straightening rollers and a push-in amount of the welding wire in the first roller group and a second roller group.

FIG. 7 is a conceptual view under an assumption that a welding wire is linearly disposed so as to be in contact with the groove bottom of a first roller {(n−2)th roller} and a third roller (nth roller).

FIG. 8A is a conceptual view illustrating a relationship between the straightening rollers and the welding wire when the radius of the straightening rollers is relatively large.

FIG. 8B is a conceptual view illustrating a relationship between the straightening rollers and the welding wire when the radius of the straightening rollers is smaller than the radius in FIG. 8A.

FIG. 9A is a conceptual view illustrating a relationship between the straightening rollers and the welding wire when the arrangement interval between the straightening rollers is relatively large.

FIG. 9B is a conceptual view illustrating a relationship between the straightening rollers and the welding wire when the arrangement interval between the straightening rollers is smaller than the arrangement interval in FIG. 9A.

FIG. 10 is a schematic view of a target property test apparatus.

FIG. 11 is a schematic view of a feed resistance test apparatus.

FIG. 12 is a table showing test results regarding the target property and the feed resistance in Examples 1 to 4.

FIG. 13A is a table showing test results regarding the target property and the feed resistance in Comparative Examples 1 to 5.

FIG. 13B is a table showing test results regarding the target property and the feed resistance in Comparative Examples 6 to 10.

### DESCRIPTION OF EMBODIMENTS

An embodiment of a welding-wire-straightening apparatus according to the present invention will be described in detail below based on the drawings. Note that the embodiment described below is an example of implementation of the present invention, and it is not intended to limit the configuration of the present invention to the specific example. Therefore, the technical scope of the present invention is not limited to the content disclosed in the present embodiment.

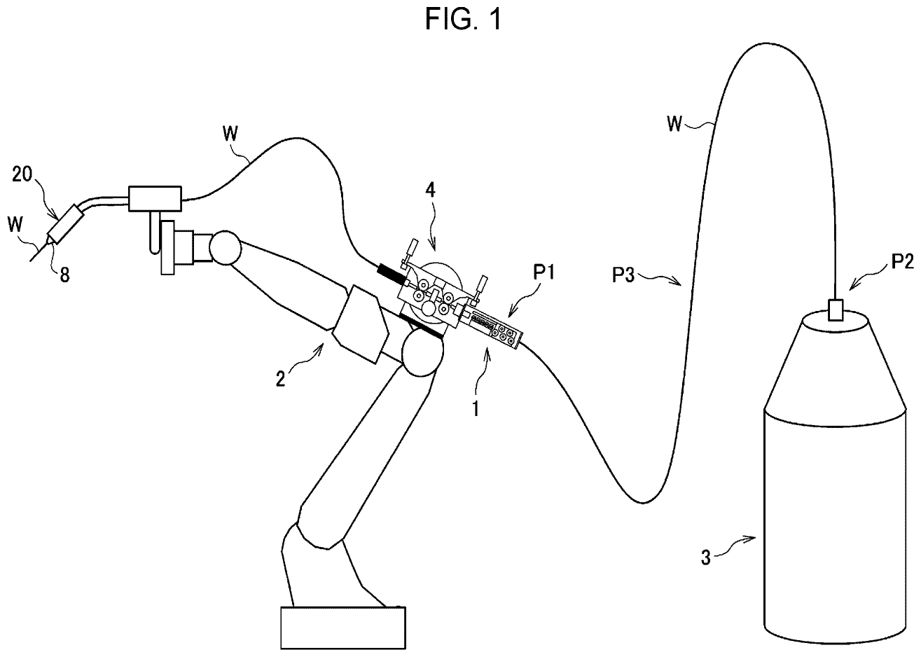

Before a description is given for a welding-wire-straightening apparatus 1 according to the embodiment of the present invention, a process of straightening a welding wire W to be fed to a welding torch 20 will be described with reference to FIG. 1. FIG. 1 is a schematic view for schematically explaining a process of passing the welding wire W drawn out from a pack 3 through the welding-wire-straightening apparatus 1 according to the present embodiment, and feeding the welding wire W to the welding torch 20 of a welding robot 2.

Referring to FIG. 1, the welding wire W is wound in e.g., a ring shape, and stored in the pack 3, then is drawn out from the upper end of the pack 3.

As the welding wire W, for example, a solid wire may be used. In other words, the welding-wire-straightening apparatus 1 of the present embodiment is preferably used to mainly straighten curl and twist of a solid wire.

The welding wire W drawn out from the pack 3 is fed to e.g., the welding torch 20 provided at the distal end of the arm of the welding robot 2, and is passed through the welding-wire-straightening apparatus 1 according to the present embodiment before the welding torch 20.

Passage of the welding wire W through the welding-wire-straightening apparatus 1 eliminates curl and twist of the welding wire W due to the storage thereof in the pack 3, thus substantially linear welding wire W without curl and twist is obtained. The linear welding wire W is fed by a feeding device 4 to the welding torch 20 that performs arc welding, and passed through the distal end of the welding torch 20. The distal end of the welding torch 20 is provided with a contact chip 8.

At this point, when various curls and twists remain in portions of the welding wire W, the distal end of the welding wire W is deflected from a target position of the welding torch 20 according to the degree of the curl and the degree of the twist, that is, so-called “wire deflection” occurs. When the “wire deflection” occurs, the wire target property deteriorates, and the welding wire W cannot be melted by an arc along a correct weld line, thereby causing a weld defect such as bead meandering and lack of fusion, and satisfactory weld joint cannot be obtained. Thus, in order to improve the target property by reducing the wire deflection, the welding-wire-straightening apparatus 1 that linearly straightens the welding wire W plays an extremely important role.

In FIG. 1, the welding-wire-straightening apparatus 1 (hereinafter referred to as the straightening apparatus 1) is provided at a position P1 on the robot arm of the welding robot 2, but may be provided at a position P2 immediately after the welding wire W is drawn out from the pack 3, or in a position P3 between the pack 3 and the welding robot 2. However, in order to reduce the wire-feed resistance, and improve the wire target property, it is preferable that the wire be straightened near the arc spot. Therefore, it is more preferable that the straightening apparatus 1 be provided at the position P1 on the robot arm. The straightening apparatus 1 is preferably small in size regardless of its installation position P1, P2, or P3 so that the straightening apparatus 1 is unlikely to be restricted by the size and shape of the installation space. Particularly, when provided on the robot arm, such as in the position P1, the straightening apparatus 1 is desirably small in size particularly to avoid restrictions on the range of motion of the welding robot 2.

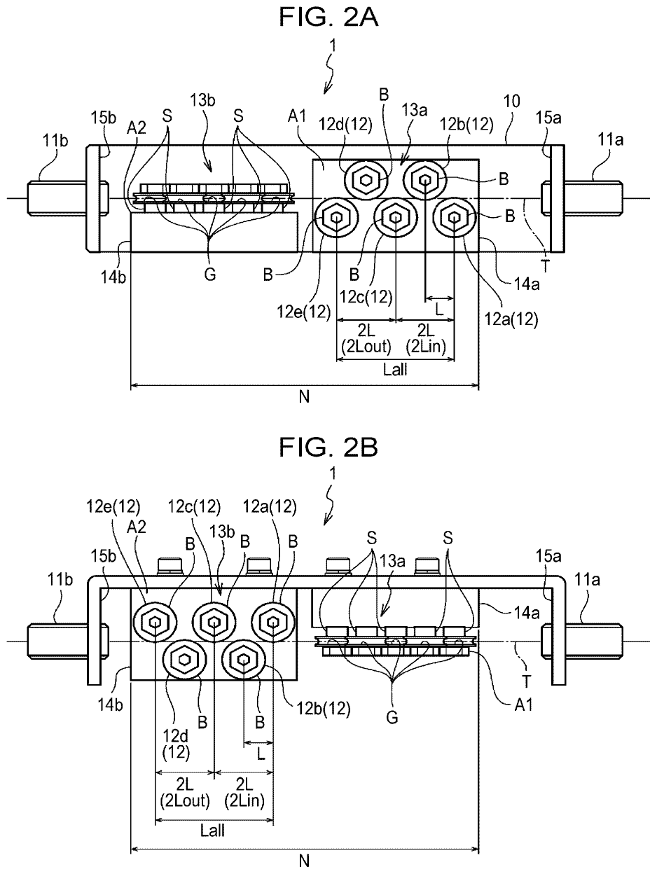

The configuration of the straightening apparatus 1 will be described below with reference to FIGS. 2A and 2B. FIG. 2A is a front view as seen from the front of the straightening apparatus 1. FIG. 2B is a top view illustrating the state of the straightening apparatus 1 illustrated in FIG. 2A as seen from above with respect to the paper surface, in other words, the state of the upper surface side of the straightening apparatus 1.

Referring to FIG. 2A, the straightening apparatus 1 includes a frame 10, two guide pipes (hereinafter referred to as guide bodies) 11a, 11b provided at both ends of the frame 10, a first roller group 13a and a second roller group 13b which are two roller groups each including a plurality of straightening rollers 12, and two bases, that is, a first base 14a and a second base 14b that respectively support the first roller group 13a and the second roller group 13b, the two bases being fixed to the frame 10. The straightening apparatus 1 straightens the bend of the welding wire W by passing the welding wire W through the first roller group 13a and the second roller group 13b. In the example illustrated, a space intervenes between the first base 14a and the second base 14b; however, the first base 14a and the second base 14b may be in contact with each other.

The frame 10 is a plate-like member having a rectangular flat plate surface, and has two substantially the same flat plate-like wall plates 15a, 15b provided substantially perpendicular to the flat plate surface at both longitudinal ends of the flat plate surface. The two wall plates 15a, 15b are provided in the same direction and substantially perpendicular to the flat plate surface, and are substantially parallel and opposed to each other.

The guide bodies 11a, 11b, are each a pipe body that is a member having a through-hole in the longitudinal direction of the pipe body. The through-holes of the guide pipes 11a, 11b have a diameter sufficiently larger than the diameter t of the welding wire W.

As illustrated in FIG. 2A, the guide bodies 11a, 11b with substantially matched central axes of the through-holes penetrate the wall plates 15a, 15b, and are held by the wall plates 15a, 15b. The guide body 11a is held by the wall plate 15a, and the guide body 11b is held by the wall plate 15b.

The welding wire W which has passed through the through-hole of one guide body 11a from the outside of the frame 10, e.g., from the right side of the paper surface of FIG. 2A goes through the frame 10 substantially linearly to the other guide body 11b, and exits to the outside of the frame 10 through the through-hole of the other guide body 11b. At this point, the path along which the welding wire W passes in the frame 10 is the straight line indicated by a dashed line in FIGS. 2A and 2B, and called a straightening path T.

Each of the first roller group 13a and the second roller group 13b is formed by the later-described five straightening rollers 12 which are disposed to be opposed to each other across the straightening path T in the passing direction of the welding wire W with a predetermined arrangement interval L. Before a description is given for the configuration of the first roller group 13a and the second roller group 13b, the configuration of the straightening rollers 12 will be described in detail.

As illustrated in FIG. 6, each straightening roller 12 has a disk shape with a thickness greater than the diameter t of the welding wire W, and is a member rotatable around the axis of the disk shape. In the present embodiment, the straightening roller 12 is comprised of a bearing such as a rolling bearing having an inner ring (hereinafter referred to an inner race), an outer ring (hereinafter referred to an outer race) and a rolling element. The straightening roller 12 is made of e.g., stainless steel.

Therefore, the straightening roller 12 is comprised of a member that forms a bearing having an inner race, an outer race and a rolling element. The thickness of the outer race along the axis of rotation of the straightening roller 12 is larger than the diameter t of the welding wire W.

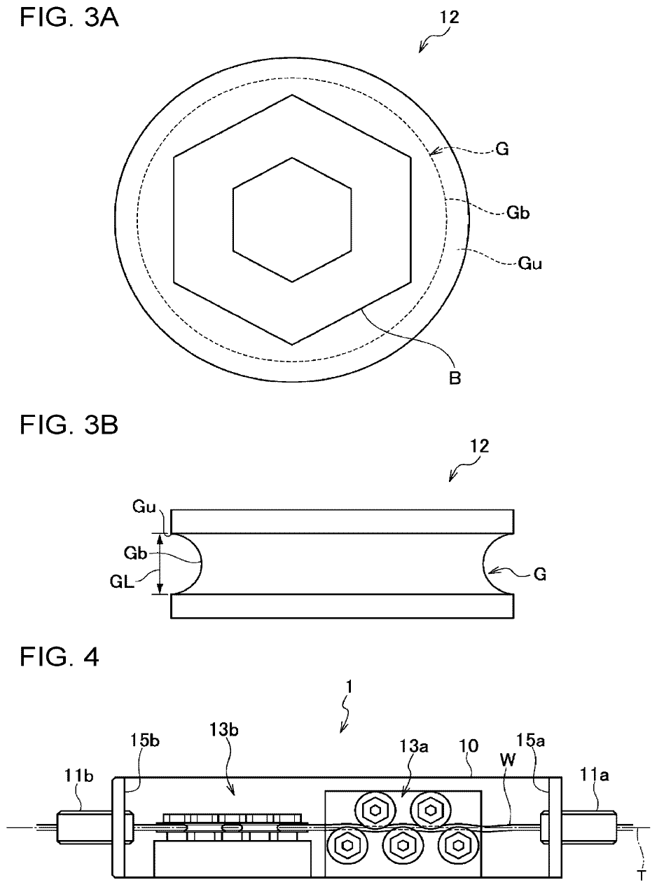

FIG. 3A is a front view of the straightening roller, and FIG. 3B is a top view of the straightening roller. Note that in FIG. 3B, illustration of a bolt B to fix the straightening roller 12 is omitted. As illustrated in FIGS. 3A and 3B, in the outer circumferential surface of the outer race of the straightening roller 12, a groove is formed over the entire circumference in the circumferential direction of the outer race, in other words, in the rotational direction of the outer race. Hereinafter, the groove is called the straightening groove G.

The straightening groove G may have any cross-sectional shape, and arc, U-shape, rectangle and V-shape are exemplified. In the example illustrated, the cross-sectional shape of the straightening groove G is semicircular arc. It is preferable that an upper end Gu of the straightening groove G be sufficiently above the position at which the welding wire W is in contact with the wall surface of the straightening groove G, and an opening width GL of the straightening groove G be slightly larger than the diameter t of the welding wire W. When the opening width GL of the straightening groove G is formed to be slightly larger than the diameter t, the upper end Gu of the straightening groove G can serve as a holding part to reduce excessive deviation or vibration of the welding wire W in the straightening groove G.

The first roller group 13a and the second roller group 13b will be described with reference to FIGS. 2A and 2B.

In each the first and second roller groups 13a, 13b, a plurality of straightening rollers 12 are such that a first roller 12a, a second roller 12b, . . . , nth roller are sequentially disposed in the passing direction (from the right side to the left side in FIGS. 2A and 2B) of the welding wire W, and bending deformation is applied to the welding wire W alternately in opposite directions by these n rollers to straighten the curl of the welding wire W, where n is an integer greater than or equal to 4. Note that in the example illustrated, n=5, and the plurality of straightening rollers 12 include the first roller 12a, the second roller 12b, the third roller 12c, the fourth roller 12d, the fifth roller 12e which are sequentially disposed in the passing direction of the welding wire W. With the number n of straightening rollers 12 set to 5, it is possible to miniaturize the welding-wire-straightening apparatus 1 while stabilizing the target property of the welding wire W.

The first roller group 13a is formed by arranging the above-mentioned five straightening rollers 12 so that the direction of formation of the straightening groove G of each straightening roller 12, which is the rotational direction of the straightening roller 12, conforms with the direction of formation of the straightening path T. The arrangement of the five straightening rollers 12 will be described below.

The five straightening rollers 12 in the first roller group 13a are such that in the vertical direction when the paper surface of FIG. 2A is viewed, two straightening rollers 12b, 12d are disposed above the straightening path T indicated by a dash line, and three straightening rollers 12a, 12c, 12e are disposed below the straightening path T. The two upper straightening rollers 12 are disposed along the straightening path T with a predetermined interaxial distance 2L, and similarly, the three lower straightening rollers 12 are also disposed along the straightening path T with a predetermined interaxial distance 2L. In addition, the upper straightening rollers 12 and the lower straightening rollers 12 are opposed to each other so as to interpose the straightening path T between the straightening grooves G in the vertical directions of FIG. 2A which are opposite directions.

The five straightening rollers 12 in the first roller group 13a are disposed so that the opposed straightening rollers 12 across the straightening path T are not opposed in a direction perpendicular to the straightening path T, but opposed in a direction diagonal to the straightening path T. Specifically, each of the second roller 12b, the fourth roller 12d which are the two upper straightening rollers is disposed to face the straightening path T at a position corresponding to a substantially center of the interaxial distance 2L between the first roller 12a, the third roller 12c, and the fifth roller 12e which are the lower adjacent straightening rollers. In other words, the first roller 12a, the third roller 12c, the fifth roller 12e which are the lower three straightening rollers are disposed so that the second roller 12b, the fourth roller 12d which are the two upper straightening rollers are opposed to the straightening path T at a position corresponding to a center of the interaxial distance 2L between the first roller 12a, the third roller 12c, the fifth roller 12e which are adjacent straightening rollers. That is, the arrangement interval L between the plurality of straightening rollers 12 is half the interaxial distance 2L between the upper or lower adjacent straightening rollers 21. Note that the arrangement interval L refers to the interaxial intervals along the straightening path T between straightening rollers 12a and 12b, 12b and 12c, 12c and 12d, 12d and 12e, and may be equal values or different values.

Although the details will be described later, of the interaxial distances 2L of adjacent five straightening rollers 12 in the first roller group 13a, the interaxial distance 2L between the first roller 12a and the third roller 12c on the wire entrance side is particularly denoted by 2Lᵢₙ, and the interaxial distance 2L between the fifth roller 12e and the third roller 12c on the wire exit side is particularly denoted by 2Lₒᵤₜ.

As described above, the first roller group 13a where the five straightening rollers 12 are disposed is supported by the first base 14a. The first base 14a is e.g., a rectangular parallelepiped member comprised of the same material as that of the frame 10, and is in contact with the frame 10 at one lateral surface, and is fixed to the frame 10. The first base 14a supports the first roller group 13a on a support surface A1, that is the lateral surface on the opposite side to the surface in contact with the frame 10, in other words, the lateral surface parallel to the surface in contact with the frame 10.

Each straightening roller 12 in the first roller group 13a is supported on the support surface A1 via the bolts B which penetrate the inner race, and are screwed into bolt holes provided in advance in the support surface A1 of the first base 14a. At this point, each straightening roller 12 may be supported on the support surface A1 with a spacer S interposed between the support surface A1 and the straightening roller 12, the spacer S for keeping a constant distance from the support surface A1. When the spacer S is used, the inner race of each straightening roller 12 is sandwiched by the head of a bolt B to be screwed into the bolt hole of the support surface A1, and the spacer S in contact with the support surface A1, thus each straightening roller 12 is supported on the support surface A1 of the first base 14a.

When each straightening roller 12 is held by installing the spacer S with an appropriate thickness between the first base 14a and the straightening roller 12, the first roller group 13a can be disposed at the above-mentioned position with respect to the straightening path T by fixing the first base 14a to the frame 10.

FIG. 2B is a view illustrating the state the straightening apparatus 1 illustrated in FIG. 2A as seen from above with respect to the paper surface. As illustrated in FIG. 2B, each straightening roller 12 in the first roller group 13a is disposed so that the straightening groove G substantially overlaps with the straightening path T.

As described above, each straightening roller 12 included in the first roller group 13a is fixed to a predetermined position with respect to the first base 14a, and the first base 14a is fixed to a predetermined position of the frame 10, thus the arranged position of each straightening roller 12 included in the first roller group 13a is fixed in the frame 10. Therefore, it can be said that the first roller group 13a is non-adjustment type which needs no change of the arranged position of each straightening roller 12 in the frame 10.

As in the first roller group 13a, the second roller group 13b is formed by five straightening rollers consisting of the first roller 12a, the second roller 12b, . . . , the fifth roller 12e, and is supported by the support surface A2 of the second base 14b which has substantially the same configuration as that of the first base 14a. That is, the second roller group 13b has substantially the same configuration as that of the first roller group 13a, and is non-adjustment type as with the first roller group 13a. The straightening rollers 12 included in the second roller group 13b are opposed to each other so as to interpose the straightening path T by the straightening grooves G in opposite directions.

The second roller group 13b differs from the first roller group 13a in the following point. The second roller group 13b is disposed so that the opposing directions of the straightening rollers 12 across the straightening path T in the second roller group 13b are different from the opposing directions of the straightening rollers 12 in the first roller group 13a.

Specifically, the opposing directions of the straightening rollers 12 across the straightening path T in the second roller group 13b are obtained by rotating the opposing directions of the straightening rollers 12 in the first roller group 13a approximately 90 degrees.

In order to implement the above-described arrangement of the second roller group 13b, the second base 14b that supports the second roller group 13b is brought into contact with the frame 10 at the lateral surface adjacent to the support surface A2 that supports the second roller group 13b, and is fixed to the frame 10 so as to be adjacent to the first roller group 13a.

As illustrated in FIG. 2B, the straightening rollers 12 in the second roller group 13b are opposed in a direction diagonal to the straightening path T across the straightening path T, and are disposed so that the straightening grooves G substantially overlap with the straightening path T as illustrated in FIG. 2A. In other words, in the first roller group 13a and the second roller group 13b, the arrangement of the straightening rollers 12 with respect to the straightening path T only differ in rotation of 90 degrees, and are substantially the same.

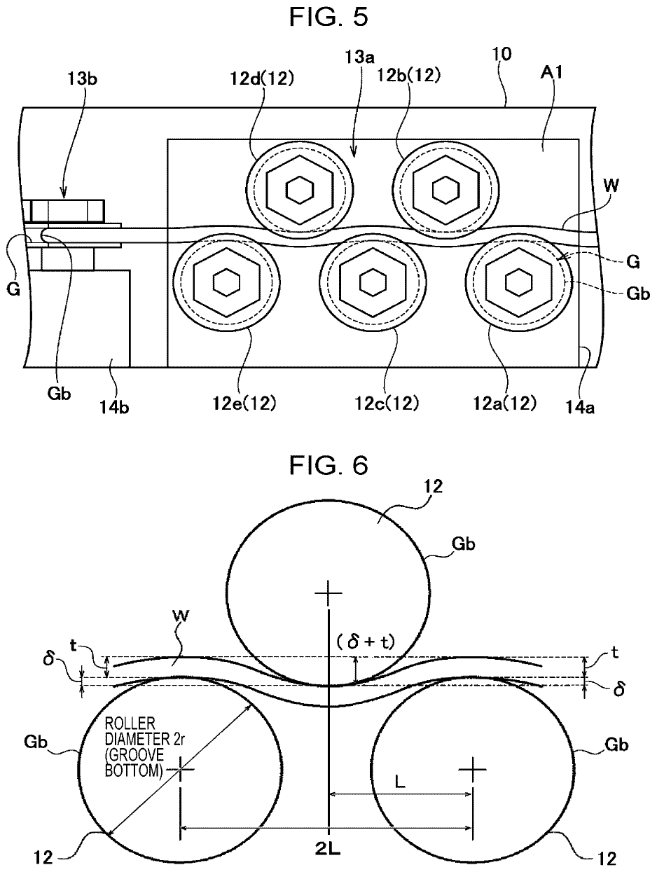

Referring to FIGS. 4 and 5, a relationship between the straightening apparatus 1 including the aforementioned first roller group 13a and second roller group 13b, and the welding wire W passing through the straightening path T will be described. FIG. 4 is a view as seen from the front of the straightening apparatus 1 illustrated in FIG. 2A with the welding wire W passed through the straightening apparatus 1. FIG. 5 is an enlarged view illustrating the first roller group 13a of straightening apparatuses 1 with magnification.

As illustrated in FIG. 4, for example, the welding wire W which has passed through the through-hole of one guide pipe 11a from the outside of the frame 10 goes through the first roller group 13a and the second roller group 13b along the straightening path T, passes through the frame 10 substantially linearly to the other guide pipe 11b, and exits to the outside of the frame 10 through the through-hole of the other guide pipe 11b.

The welding wire W which is passed through the first roller group 13a and the second roller group 13b alternately receives a pressing force in completely opposite directions from five straightening rollers 12 in each roller group of the first roller group 13a and the second roller group 13b.

Referring to the enlarged view of the first roller group 13a illustrated in FIG. 5, it can be seen that the welding wire W successively comes into contact with five straightening rollers 12 in the first roller group 13a, thus alternately receives a pressing force from above and a pressing force from below with respect to the paper surface of FIG. 5, and is slightly curved vertically. In addition, in the second roller group 13b, the welding wire W receives a pressing force from a direction approximately 90 degrees different from the direction of the pressing force received in the first roller group 13a, in other words, alternately receives a pressing force from the right side and a pressing force from the left side with respect to the passing direction of the welding wire W, and is slightly curved to the right or left.

In this manner, the welding wire W is alternately curved up/down or right/left by passing through the first roller group 13a and the second roller group 13b, and after passing through the second roller group 13b, the welding wire W becomes substantially linear, and is drawn to the outside of the straightening apparatus 1.

In the description of the first roller group 13a and the second roller group 13b, the arrangement of the straightening rollers 12 in the direction along the straightening path T has been mainly described. Next, the arrangement of the straightening rollers 12 in the opposing direction with respect to the straightening path T will be described in detail below.

Referring to FIG. 6, the configuration of the first roller group 13a and the second roller group 13b, including the arrangement of the straightening rollers 12 in the opposing directions will be described in detail. FIG. 6 is a conceptual view conceptually illustrating a relationship between the arrangement of the straightening rollers 12 and the push-in amount of the welding wire W in the first roller group 13a and the second roller group 13b.

As illustrated in FIG. 6, the positional relationship in the opposing directions between the straightening rollers 12 included in the first roller group 13a and the second roller group 13b will be described using four parameters: the interaxial distance 2L between adjacent straightening rollers 12, the diameter 2r of each straightening roller 12, the diameter t of the welding wire W, and the engaging amount δ of each straightening roller 12.

The interaxial distance 2L between adjacent straightening rollers 12 is the distance between the axes which are the centers of rotation of the adjacent straightening rollers 12, and the arrangement interval L between the straightening rollers 12 is set to half the interaxial distance 2L. The diameter 2r of each straightening roller 12 is twice the distance from the axis of the straightening roller 12 to the groove bottom Gb of the straightening groove G. Thus, the distance from the axis of the straightening roller 12 to the groove bottom Gb is the roller radius r.

The radius r of the straightening roller 12 of the present embodiment is preferably less than 7 mm, more preferably less than or equal to 6.5 mm, and even more preferably less than or equal to 6 mm. The entire straightening apparatus 1 can be miniaturized by using small diameter straightening rollers 12 having a radius r less than 7 mm. Conversely, when the radius r of straightening roller 12 is greater than or equal to 7 mm, appropriate deformation of the welding wire W is not obtained, and the welding-wire-straightening apparatus 1 will increase in size. For a smaller radius r of the straightening roller 12, the bearing diameter also needs to be smaller; however, the bearing with a small diameter may cause reduction in the bearing life, or rotational failure because the bearing has a low rated load, and cannot bear a load. Therefore, the radius r of the straightening roller 12 is preferably greater than or equal to 5 mm, more preferably greater than or equal to 5.5 mm, and even more preferably greater than or equal to 6 mm.

The diameter t of the welding wire W is the wire diameter of the welding wire W. For example, the diameter t is assumed to be greater than or equal to 0.8 mm and less than or equal to 1.6 mm. However, the diameter t is not limited to the above-mentioned numerical value range, and may be any value.

As illustrated in FIG. 6, the engaging amount δ of the straightening roller 12 is a value that, when the groove bottoms Gb of two straightening rollers 12 opposed across the above-mentioned straightening path T are seen along the straightening path T, represents the amount of overlap between the straightening rollers 12. When seen along the straightening path T, the groove bottoms Gb of two straightening rollers 12 overlap to cross the straightening path T, and it can be stated that the straightening rollers 12 are engaged with each other by the amount of the overlap, thus the amount of overlap between the straightening rollers 12 is called the engaging amount δ of the straightening rollers 12.

The engaging amount δ caused by the first roller 12a, the second roller 12b and the third roller 12c on the entrance side may be called an entrance roller engaging amount δᵢₙ (mm). In the example illustrated, the first roller 12a and the third roller 12c are disposed at the same position in the opposing direction (the vertical direction in FIG. 2A) from the second roller 12b, thus the amount of overlap in the opposing direction between the first roller 12a and the second roller 12b is equal to the amount of overlap in the opposing direction between the third roller 12c and the second roller 12b. Therefore, it can be stated that the entrance roller engaging amount δᵢₙ (mm) caused by the first roller 12a, the second roller 12b and the third roller 12c is the amount of overlap in the opposing direction between the first roller 12a and the second roller 12b, or the amount of overlap in the opposing direction between the third roller 12c and the second roller 12b.

The engaging amount δ caused by the third roller 12c, the fourth roller 12d and the fifth roller 12e on the exit side may be called an exit roller engaging amount δₒᵤₜ (mm). In the example illustrated, the third roller 12c and the fifth roller 12e are disposed at the same position in the opposing direction (the vertical direction in FIG. 2B) from the fourth roller 12d, thus the amount of overlap in the opposing direction between the third roller 12c and the fourth roller 12d is equal to the amount of overlap in the opposing direction between the fourth roller 12d and the fifth roller 12e. Therefore, it can be stated that the exit roller engaging amount δₒᵤₜ (mm) caused by the third roller 12c, the fourth roller 12d and the fifth roller 12e is the amount of overlap in the opposing direction between the third roller 12c and the fourth roller 12d, or the amount of overlap in the opposing direction between the fifth roller 12e and the fourth roller 12d.

The engaging amount δ is a positive value when the groove bottoms Gb of two opposed straightening rollers 12 overlap to cross the straightening path T, or is 0 (zero) when the groove bottoms Gb are on the same line substantially parallel to the straightening path T. In addition, when the groove bottoms Gb of two opposed straightening rollers 12 are not on the same line substantially parallel to the straightening path T, and do not overlap as described above, the groove bottoms Gb of these two straightening rollers 12 are in a state of being away from the same line and spaced with an interval, thus the engaging amount δ has a negative value for a distance corresponding to this interval.

Thus, as illustrated in FIG. 6, a push-in amount (δ+t) of the welding wire W caused by the straightening rollers 12 is the sum of the engaging amount δ and the diameter t.

In each of the first and second roller groups 13a, 13b, the plurality of straightening rollers 12 are disposed and their positions are fixed in advance so that a wire deformation parameter C is in a predetermined range. Therefore, in the present embodiment, a position adjustment screw or the like for the straightening rollers is not provided.

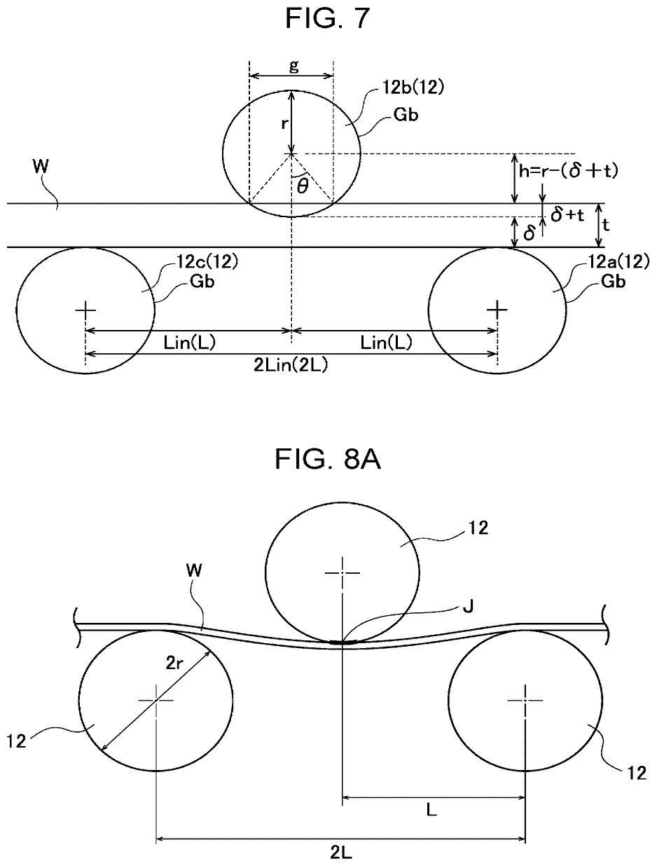

A method of calculating the wire deformation parameter C in the present embodiment will be described with reference to FIG. 7. The wire deformation parameter C can be calculated based on, for example, three consecutive rollers in the passing direction of the wire W, such as the first roller 12a, the second roller 12b and the third roller 12c. The wire deformation parameter C based on three consecutive rollers can be calculated by Expression (1) below.

$$C = L / [ {\{ ( δ + t ) / g \}}^{2} ] \qquad Expression ( 1 )$$

Where L, δ, t, g are as follows.
L: the arrangement interval between straightening rollers
δ: the engaging amount
t: the diameter of welding wire
g: the chord length of an overlapping portion of the second roller {(n−1)th roller} with the welding wire under the assumption that the welding wire is linearly disposed so as to be in contact with the first roller {(n−2)th roller} and the third roller (nth roller).

FIG. 7 is a conceptual view under the assumption that the welding wire W is linearly disposed so as to be in contact with the groove bottom Gb of the first roller 12a {(the n−2)th roller} and the third roller 12c ((the nth roller). In this case, the second roller 12b {(the (n−1)th roller} has a portion overlapped with the welding wire W by a push-in amount (δ+t) in the opposing direction from the first roller 12a {(the (n−2)th roller} and the third roller 12c ((the nth roller). Of the second roller 12b, the chord length of an overlapping portion with the welding wire W is indicated by a symbol g. The chord length g can be described as the dimension of the overlapping portion between the second roller 12b and the welding wire W in the feed direction (right-left direction of FIG. 7) of the welding wire W. Note that in FIG. 7, the chord length g can be calculated by Expression (2) below.

$$\begin{matrix}[ Math . 1 ] & \\ g = 2 h tan θ = 2 h \frac{sin θ}{cos θ} = 2 h \frac{\sqrt{1 - {( cos θ )}^{2}}}{cos θ} & Expression ( 2 )\end{matrix}$$

Where the cos θ is as follows.

$$cos θ = \frac{h}{r} = 1 - \frac{t + δ}{r} \qquad [ Math . 2 ]$$

Note that the above Expression (1) related to the wire deformation parameter C has been derived as the result of intensive research by the inventor as described below.

In the present embodiment, the local stress applied to the wire W by the straightening roller 12 will be summarized using two concepts of local stress: a stress σ1 and a stress σ2, the stress σ1 contributing to bending deformation of the wire W, the stress σ2 contributing to push-in amount of the straightening roller 12. In the present embodiment, the load due to the stress σ1 contributing to the bending deformation of the wire W is considered to have an effect on the vertical-horizontal ratio (δ+t)/L of bending deformation, and the load due to the stress σ2 contributing to the push-in amount of the straightening roller 12 is considered to have an effect on the push-in amount (δ+t). In other words, the vertical-horizontal ratio (δ+t)/L of bending deformation is used as an index indicating the load due to σ1, and the push-in amount (δ+t) is used as an index indicating the load due to σ2. In the present embodiment, σ1 and σ2 are such that stresses to a contact area J between the straightening roller 12 and the welding wire W are considered as local stresses applied to the wire W by the straightening roller 12. Here, the contact area J is considered to have an effect on the roller diameter and the chord length g of the straightening roller 12, and in the present embodiment, from the viewpoint of accuracy of the later-described stress indices, μ1 and μ2, the chord length g is used as a substitute for the contact area J. In the present embodiment, let a stress index μ1 be an index of σ1 and a stress index μ2 be an index of σ2, both σ1 and σ2 derived from elements that can serve as a substitute for the above-mentioned load or contact area. The indices μ1 and μ2 are expressed by Expression (3) below.

$$\begin{matrix}[ Math . 3 ] & \\ \{ \text{} \begin{matrix}\frac{\frac{δ + t}{L}}{g} \\ \frac{δ + t}{g} = {μ}_{2}\end{matrix} \text{} = {μ}_{1} & Expression ( 3 )\end{matrix}$$

The inventor has found that when the balance between the stress index μ1 and the stress index μ2 is not appropriate, no proper plastic deformation occurs in the wire W, and a favorable target property is not obtained. For example, regarding the stress index μ1, when the arrangement interval L between the straightening rollers 12 is decreased, the stress index μ1 increases, but when the push-in amount (δ+t) is too small, the stress index μ2 decreases. This suggests that an insufficient push-in amount of the straightening roller 12 does not cause sufficient plastic deformation of the wire. Also, when the push-in amount (δ+t) is increased, the stress index μ2 increases, but when the arrangement interval L between the straightening rollers 12 is too large, the stress index μ1 decreases. This suggests that an insufficient bending of the wire does not cause appropriate plastic deformation of the wire W. Therefore, sufficient plastic deformation can be achieved in the wire W by adjusting the balance between the stress index μ1 and the stress index μ2 appropriately.

In the present embodiment, the parameter showing the balance between the stress index μ1 and the stress index μ2 is expressed by the product of the stress index μ1 and the stress index μ2. Note that the parameter showing the balance between the stress index μ1 and the stress index μ2 may be expressed by the logarithm of the product of the stress index μ1 and the stress index μ2, or expressed by the reciprocal of the product.

In the present embodiment, from the viewpoint of easy value recognizability, the function, that is, the reciprocal of the product of μ1 and μ2 shown in Expression (4) is used as the wire deformation parameter C.

$$\begin{matrix}[ Math . 4 ] & \\ C = \frac{1}{{μ}_{1} \times {μ}_{2}} = \frac{L}{{\{ \frac{δ + t}{g} \}}^{2}} & Expression ( 4 )\end{matrix}$$

An entrance wire deformation parameter Cᵢₙ in the straightening apparatus 1 is calculated from the positional relationship between the first roller 12a, the second roller 12b and the third roller 12c based on Expression (1). Specifically, let Lᵢₙ be the arrangement interval between the first roller 12a, the second roller 12b and the third roller 12c, let δᵢₙ be the entrance roller engaging amount, let t be the diameter of the welding wire W, and let gᵢₙ be the entrance chord length which is the chord length of an overlapping portion of the second roller 12b with the welding wire W under the assumption that the welding wire W is linearly arranged to come into contact with the first roller 12a and the third roller 12c, then the entrance wire deformation parameter Cᵢₙ is calculated by the mathematical expression: Cᵢₙ=Lᵢₙ/[{(δᵢₙ+t)/gᵢₙ}²].

An exit wire deformation parameter Cₒᵤₜ in the straightening apparatus 1 is calculated from the positional relationship between the third roller 12c, the fourth roller 12d and the fifth roller 12e based on the above Expression (1).

Specifically, let Lₒᵤₜ be the arrangement interval between the third roller 12c, the fourth roller 12d and the fifth roller 12e, let δₒᵤₜ be the exit roller engaging amount, let t be the diameter of the welding wire W, and let gₒᵤₜ be the entrance chord length which is the chord length of an overlapping portion of the fourth roller 12d with the welding wire W under the assumption that the welding wire W is linearly arranged to come into contact with the third roller 12c and the fifth roller 12e, then the exit wire deformation parameter Cₒᵤₜ is calculated by the mathematical expression: Cₒᵤₜ=Lₒᵤₜ/[{(δₒᵤₜ+t)/gₒᵤₜ}²].

Note that the smaller the value of the wire deformation parameter C, the greater the displacement amount of plastic deformation of the welding wire W, and the greater the value of the wire deformation parameter C, the smaller the displacement amount of plastic deformation of the welding wire W. When the value of the wire deformation parameter C is too small, the displacement amount of plastic deformation of the welding wire W becomes excessive, and creates a curl in the welding wire, thus the target property deteriorates. Also, when the value of the wire deformation parameter C is too large, the displacement amount of plastic deformation of the welding wire W is insufficient, and the target property deteriorates.

Even if the above-mentioned parameters Cᵢₙ and Cₒᵤₜ are each in a predetermined range, when both values are small, in other words, when the displacement amount of plastic deformation of the welding wire W caused by the straightening rollers 12 is large, the feed resistance at the time of feeding the welding wire W is increased, and the welding wire W cannot be fed smoothly, which may cause poor welding. The inventor has found a correlation between a welding-wire-feed resistance parameter F and the feed resistance of the welding wire W. The welding-wire-feed resistance parameter F is calculated by Expression (5) below.

$$F = ( {L}_{in} / {C}_{in} + {L}_{out} / {C}_{out} ) \times n \qquad Expression ( 5 )$$

However, Lᵢₙ, Cᵢₙ, Lₒᵤₜ, Cₒᵤₜ, n are as follows.
Lᵢₙ: one half of the interaxial distance 2Lᵢₙ between the first roller and the third roller
Cᵢₙ: the entrance wire deformation parameter
Lₒᵤₜ: one half of the interaxial distance 2Lₒᵤₜ between the nth roller and the (n−2)th roller
Cₒᵤₜ: the exit wire deformation parameter
n: the number of straightening rollers

Note that the above Expression (5) related to the welding-wire-feed resistance parameter F has been derived as the result of intensive research by the inventor as described below.

Let f be the feed resistance occurred in the straightening apparatus 1, and 1 be the distance the welding wire is fed, then the amount of work w given to the welding wire W to pass through the straightening apparatus 1 is w=f1. The friction force to rotate the bearing is small and neglected, then the entire amount of work w should be used for plastic deformation of the welding wire W, thus the feed resistance f increases or decreases according to the stress applied to the welding wire W and the displacement amount of plastic deformation. Therefore, the feed resistance f occurred in the straightening apparatus 1 probably increases or decreases according to the index μ1×μ2=1/Cᵢₙ of the entrance stress, and the index μ1×μ2=1/Cₒᵤₜ of the exit stress of the welding wire W.

The larger the area where plastic deformation occurs in the welding wire W, that is, the larger the roller arrangement interval L, the longer the wire W plastically deformed, thus it is expected that the feed resistance increases. In addition, it is expected that the greater the number of straightening rollers, the higher the feed resistance.

Thus, in the present embodiment, the feed resistance parameter F represented by Expression (5) is defined as the index of the feed resistance of the welding wire W, which occurs in the straightening apparatus 1.

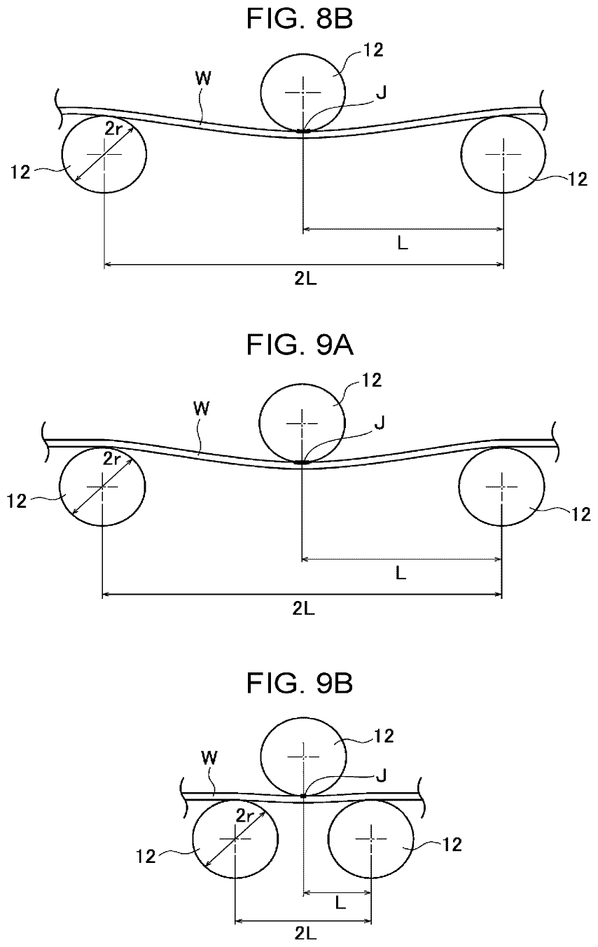

The relationship between the wire deformation parameter C, and various parameters L, δ, t, g included in the wire deformation parameter C will be described with reference to FIGS. 8A to 9B.

FIG. 8A is a conceptual view illustrating a relationship between straightening rollers 12 and the welding wire W when the radius r of the straightening rollers 12 is relatively large, for example, greater than or equal to 7 mm. FIG. 8B is a conceptual view illustrating a relationship between straightening rollers 12 and the welding wire W when the radius r of the straightening rollers 12 is smaller than in FIG. 8A, for example, less than 7 mm. FIG. 9A is a conceptual view illustrating a relationship between the straightening rollers 12 and the welding wire W when the arrangement interval L between the straightening rollers 12 is relatively large, for example, greater than 8.75 mm. FIG. 9B is a conceptual view illustrating a relationship between the straightening rollers 12 and the welding wire W when the arrangement interval L between the straightening rollers 12 is smaller than in FIG. 9A, for example, less than or equal to 8.75 mm.

As illustrated in FIG. 8B, when the radius r of each straightening roller 12 is smaller than the radius in FIG. 8A, the contact area J between the straightening roller 12 and the welding wire W is small. Note that the smaller the radius r, the smaller the chord length g based on Expression (2). In addition, as illustrated in FIG. 9B, when the arrangement interval L between the straightening rollers 12 is smaller than that of FIG. 9A, the contact area J between each straightening roller 12 and the welding wire W becomes smaller. In other words, when the radius r of the straightening roller 12 is reduced (when the chord length g is reduced) or when the arrangement interval L between the straightening rollers 12 is shortened, the contact area J is reduced, and a local load is likely to be applied to the welding wire W. Although not illustrated, when the engaging amount δ or the diameter t of the welding wire W is increased, the push-in amount (δ+t) increases, thus naturally, the displacement amount of plastic deformation of the welding wire W and the feed resistance also increase. In any case (when the radius r or the arrangement interval L is reduced, or when the engaging amount δ or the diameter t is increased), the wire deformation parameter C decreases.

Conversely, when the radius r of the straightening roller 12 is increased (when the chord length g is increased) or when the arrangement interval L between the straightening rollers 12 is increased, the contact area J is made large, thus a local load is unlikely to be applied to the welding wire W. Therefore, the displacement amount of plastic deformation of the welding wire W and the feed resistance decrease. Although not illustrated, when the engaging amount δ or the diameter t of the welding wire W is decreased, the push-in amount (δ+t) decreases, thus naturally, the displacement amount of plastic deformation of the welding wire W and the feed resistance decrease. In any case (when the radius r or the arrangement interval L is increased, or when the engaging amount δ or the diameter t is decreased), the wire deformation parameter C increases.

Thus, in the present embodiment, the target property of the welding wire and reduction in the feed resistance are both achieved by setting the wire deformation parameter C and the welding-wire-feed resistance parameter F to an appropriate range.

Here, the lower limit of the entrance wire deformation parameter Cᵢₙ is 1150. The lower limit of the entrance wire deformation parameter Cᵢₙ is more preferably 1200, and even more preferably 1300. The upper limit of the entrance wire deformation parameter Cᵢₙ is 1500. The upper limit of the entrance wire deformation parameter Cᵢₙ is more preferably 1450, and even more preferably 1400. The lower limit of the exit wire deformation parameter Cₒᵤₜ is 4300. The lower limit of the exit wire deformation parameter Cₒᵤₜ is more preferably 4400, and even more preferably 4500. The upper limit of the exit wire deformation parameter Cₒᵤₜ is 49000. The upper limit of the exit wire deformation parameter Cₒᵤₜ is more preferably 38400, even more preferably 10000, still more preferably 8000, and still even more preferably 7000. The welding-wire-straightening apparatus 1 having a favorable target property can be achieved by setting the entrance wire deformation parameter Cᵢₙ and the exit wire deformation parameter Cₒᵤₜ in such a preferred range.

Note that when the entrance wire deformation parameter Cᵢₙ falls below the above-mentioned lower limit, i.e., Cᵢₙ<1150, the displacement amount of plastic deformation of the welding wire W is too large, which gives an excessive curl to the welding wire W, which cannot be straightened by the straightening rollers 12 on the exit side of the straightening apparatus, thus the target property deteriorates. Also, when the exit wire deformation parameter Cₒᵤₜ falls below the above-mentioned lower limit, i.e., Cₒᵤₜ<4300, the displacement amount of plastic deformation of the welding wire W caused by the straightening rollers 12 on the exit side is too large, which gives an excessive curl to the welding wire W, thus the target property deteriorates.

In addition, when the entrance wire deformation parameter Cᵢₙ and the exit wire deformation parameter Cₒᵤₜ exceed the above-mentioned lower limit, i.e., 1500<Cᵢₙ and 49000<Cₒᵤₜ, the displacement amount of plastic deformation of the welding wire W is insufficient, and the target property deteriorates. In such a case, wire deflection occurs in the distal end of the welding wire W at the time of welding, and welding quality may become unstable.

The lower limit of the welding-wire-feed resistance parameter F is not particularly specified, but is preferably greater than or equal to 0.014, more preferably greater than or equal to 0.017, and even more preferably greater than or equal to 0.021. The upper limit of the welding-wire-feed resistance parameter F is less than 0.037. The upper limit of the welding-wire-feed resistance parameter F is more preferably less than or equal to 0.036. When the welding-wire-feed resistance parameter F exceeds the upper limit, i.e., 0.037≤F, the feed resistance increases.

Note that in the present embodiment, the position of the straightening roller 12 does not need to be adjusted by a position adjustment screw or the like, thus a stable favorable straightening effect can be obtained all the time.

Note that in the example illustrated, in each of the roller groups 13a, 13b, the number n of straightening rollers 12 is set to 5, but in the present invention, the number n of straightening rollers 12 can be set to any number greater than or equal to 4. As a general example, when the straightening apparatus has n rollers, the entrance wire deformation parameter Cᵢₙ can be calculated from the positional relationship or the like between the first roller 12a, the second roller 12b and the third roller 12c. In addition, the exit wire deformation parameter Cₒᵤₜ can be calculated from the positional relationship or the like between the (n−2)th roller, the (n−1)th roller and the nth roller.

The radius r of the plurality of straightening rollers 12 in the present embodiment is preferably greater than or equal to 5 mm, more preferably greater than or equal to 5.5 mm, and even more preferably greater than or equal to 6 mm. In addition, the radius r of the straightening rollers 12 is preferably less than 7 mm, more preferably less than 6.5 mm, and even more preferably less than 6 mm. Using such radius r, the wire deformation parameter C and the welding-wire-feed resistance parameter F can have favorable numerical values while miniaturizing the straightening apparatus 1.

The arrangement interval L between the plurality of straightening rollers 12 in the present embodiment is preferably greater than or equal to 5 mm, more preferably greater than or equal to 6 mm, and even more preferably greater than or equal to 7 mm. In addition, the arrangement interval L between the straightening rollers 12 is preferably less than or equal to 8.75 mm, more preferably less than or equal to 8.5 mm, and even more preferably less than or equal to 8 mm. Using such an arrangement interval L, the wire deformation parameter C and the welding-wire-feed resistance parameter F can have favorable numerical values while miniaturizing the straightening apparatus 1.

In each of the first and second roller groups 13a, 13b, the interaxial distance Lan between the first roller 12a located closest to the entrance side, and the fifth roller 12e located closest to the exit side is preferably less than or equal to 35 mm, more preferably less than or equal to 34 mm, and even more preferably less than or equal to 33 mm. In addition, the interaxial distance Lₐₗₗ is preferably greater than 20 mm. The interaxial distance Lₐₗₗ can be expressed by a relational expression between the arrangement interval L and the number n of the straightening rollers 12 included in each of the roller groups 13a, 13b, that is, Lₐₗₗ=L×(n−1). Specifically, since n=5 in the example illustrated, Lₐₗₗ=4 L. By setting the interaxial distance Lan to the above-mentioned range, the wire deformation parameter C can have a favorable numerical value while miniaturizing the straightening apparatus 1.

Note that in the example illustrated, the number n of straightening rollers 12 is 5, but even when the number n of straightening rollers 12 is changed, the interaxial distance Lₐₗₗ between the first roller 12a located closest to the entrance side, and the nth roller located closest to the exit side is preferably set in the above-mentioned preferred range.

Also, a total length N (see FIGS. 1 and 2) of the first roller group 13a and the second roller group 13b of the straightening apparatus 1 is preferably less than or equal to 110 mm, more preferably less than or equal to 105 mm, and even more preferably less than or equal to 100 mm. The total length N of the first roller group 13a and the second roller group 13b of the straightening apparatus 1 is the length between the entrance lateral surface of the first base 14a and the exit lateral surface of the second base 14b in the passing direction of the welding wire W. Like this, the straightening apparatus 1 has the total length N less than or equal to 110 mm, so is small in size, thus is unlikely to be restricted by the size and shape of the installation space, and when the straightening apparatus 1 is provided on the robot arm, such as the point P1 (see FIG. 1), the range of motion of the welding robot 2 can be made wider.

The total length N of the first roller group 13a and the second roller group 13b of the straightening apparatus 1 is preferably greater than 60 mm.

The entrance roller push-in amount (δᵢₙ+t) caused by the first roller 12a, the second roller 12b and the third roller 12c on the entrance side is preferably less than or equal to 0.35 mm.

The entrance roller push-in amount (δᵢₙ+t) is preferably greater than or equal to 0.10 mm.

The exit roller push-in amount (δₒᵤₜ+t) caused by the (n−2)th roller, the (n−1)th roller and the nth roller on the exit side is preferably less than or equal to 0.1 mm.

The exit roller push-in amount (δₒᵤₜ+t) is preferably greater than or equal to 0 mm.

The first roller group 13a and the second roller group 13b shown in the present embodiment use parameters in the same structure, the same conditions, but even if the first roller group 13a and the second roller group 13b are in different structures, and different conditions in the scope of the present invention, the first and second roller groups provide the effects of the present invention. For example, in the first roller group 13a and the second roller group 13b, the entrance wire deformation parameters Cᵢₙ may differ in a range of 1150 to 1500, the exit wire deformation parameters Cₒᵤₜ may differ in a range of 4300 to 49000, and the welding-wire-feed resistance parameters F may differ in a range less than 0.037.

### EXAMPLE

Hereinafter, the test results when the welding wire W is straightened by the welding-wire-straightening apparatus 1 according to Example will be specifically described in comparison with the test results obtained in a Comparative Example.

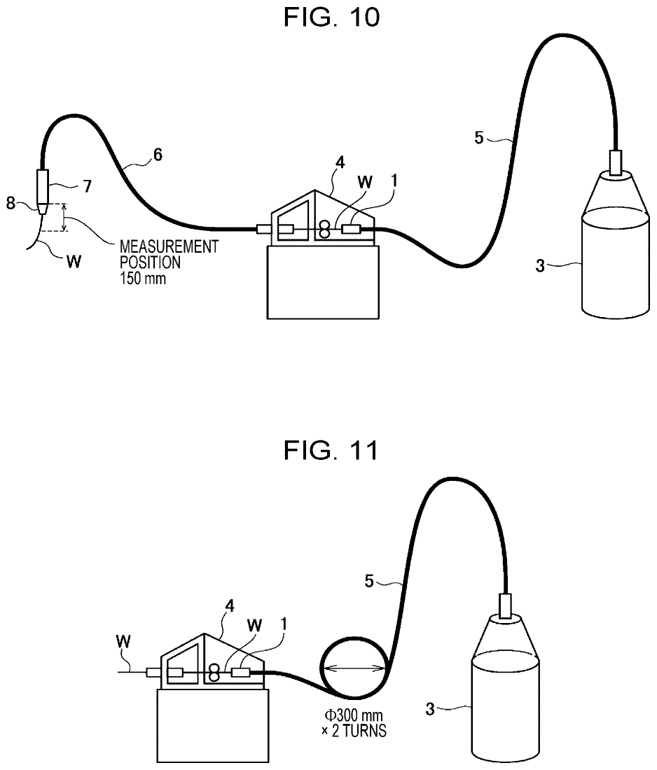

FIG. 10 is a schematic view of a target property test apparatus. As illustrated in FIG. 10, in the target property test apparatus, the straightening apparatus 1 is disposed in the feeding device 4. A conduit cable 5 is connected at one end to the exit side of the pack 3, and connected at the other end to the straightening apparatus 1 in the feeding device 4. Therefore, the welding wire W is passed through the conduit cable 5, and inserted into the straightening apparatus 1 in the feeding device 4. The exit side of the feeding device 4 is coupled to a welding torch 7 via a conduit cable 6, and the contact chip 8 (hereinafter referred to as the chip 8) is provided at the distal end of the welding torch 7.

In the target property test apparatus configured in this manner, when the feeding device 4 is driven, the welding wire W drawn out from the pack 3 is moved in the conduit cable 5, and fed to the straightening apparatus 1, then curl is straightened. Subsequently, the welding wire W is sent out to the chip 8 of the welding torch 7 through the feeding device 4 and the conduit cable 6.

The welding wire W sent out from the chip 8 was caused to project from the distal end of the chip 8, and the target property of the welding wire W was tested by measuring the coordinate position of the welding wire W in the X-direction and the Y-direction at the point 150 mm away from the distal end. The X-direction and the Y-direction are perpendicular to the vertical direction in which the chip 8 extends in FIG. 10. The number of measurements of the XY coordinate position is greater than or equal to 100 times, and after each measurement, the welding wire W was cut at the exit of the chip 8.

In the straightening apparatuses 1 used in Examples and the Comparative Examples, all straightening rollers 12 are disposed at an equal arrangement interval L, and the straightening rollers 12 in the first roller group 13a and the second roller group 13b are in the same arrangement and respectively fixed to the first base 14a and the second base 14b in the same shape.

FIG. 11 is a schematic view of a feed resistance test apparatus. As illustrated in FIG. 11, in the feed resistance test apparatus, the straightening apparatus 1 is disposed in the feeding device 4. The conduit cable 5 is connected at one end to the exit side of the pack 3, and connected at the other end to the straightening apparatus 1 in the feeding device 4. Therefore, the welding wire W is passed through the conduit cable 5, and inserted into the straightening apparatus 1 in the feeding device 4. The welding wire W is sent out from the exit side of the feeding device 4. Note that the conduit cable 5 is wound 2 turns with a diameter of 300 mm at an intermediate portion, thereby increasing the feed resistance to facilitate the measurement.

The feeding device 4 includes a load cell which is not illustrated, and the feed resistance of the welding wire W is measured by the load cell. The feed speed of the welding wire W was set to 11 m/min for the measurement.

The following Table 1 shows the test conditions for Examples 1 to 4 and Comparative Examples 1 to 10.

TABLE 1

| | | | | | INTERAXIAL | ENTRANCE | | |
|---|---|---|---|---|---|---|---|---|
| | | | | | DISTANCE | WIRE | | WELDING |
| | | DIAMETER | | ARRANGEMENT | Lall | DEFOR- | | WIRE |
| | | t OF | RADIUS | INTERVAL L | BETWEEN | MATION | EXIT WIRE | FEED |
| | TOTAL | WELDING | r OF | BETWEEN | FIRST | PARAM- | DEFORMATION | RESISTANCE |
| | LENGTH | WIRE | ROLLER | ROLLERS | AND nTH | ETER | PARAMETER | PARAMETER |
| | (mm) | (mm) | (mm) | (mm) | ROLLER | Cin | Cout | F |
| EXAMPLE 1 | 100 | 1.2 | 6.0 | 8.0 | 32 | 1390 | 6368 | 0.035 |
| EXAMPLE 2 | 100 | 1.2 | 6.0 | 8.0 | 32 | 1390 | 5454 | 0.036 |
| EXAMPLE 3 | 100 | 1.2 | 6.0 | 8.0 | 32 | 1339 | 7648 | 0.035 |
| EXAMPLE 4 | 100 | 1.2 | 6.0 | 8.0 | 32 | 1390 | 9568 | 0.033 |
| COMPARATIVE | 124 | 1.2 | 7.0 | 11.0 | 44 | 1325 | 7656 | 0.049 |
| EXAMPLE 1 | | | | | | | | |
| COMPARATIVE | 100 | 1.2 | 6.0 | 8.0 | 32 | 1568 | 9568 | 0.030 |
| EXAMPLE 2 | | | | | | | | |
| COMPARATIVE | 100 | 1.2 | 6.0 | 8.0 | 32 | 1504 | 6368 | 0.033 |
| EXAMPLE 3 | | | | | | | | |
| COMPARATIVE | 100 | 1.2 | 6.0 | 8.0 | 32 | 1292 | 5454 | 0.038 |
| EXAMPLE 4 | | | | | | | | |
| COMPARATIVE | 100 | 1.2 | 6.0 | 8.0 | 32 | 1207 | 5454 | 0.040 |
| EXAMPLE 5 | | | | | | | | |
| COMPARATIVE | 100 | 1.2 | 6.0 | 8.0 | 32 | 1132 | 4235 | 0.045 |
| EXAMPLE 6 | | | | | | | | |
| COMPARATIVE | 100 | 1.2 | 6.0 | 8.0 | 32 | 1390 | 4768 | 0.037 |
| EXAMPLE 7 | | | | | | | | |
| COMPARATIVE | 100 | 1.2 | 6.0 | 8.0 | 32 | 1248 | 7648 | 0.037 |
| EXAMPLE 8 | | | | | | | | |
| COMPARATIVE | 100 | 1.2 | 6.0 | 8.0 | 32 | 1168 | 7648 | 0.039 |
| EXAMPLE 9 | | | | | | | | |
| COMPARATIVE | — | — | — | — | — | — | — | — |
| EXAMPLE 10 | | | | | | | | |
| NO | | | | | | | | |
| STRAIGHTENING | | | | | | | | |
| APPARATUS | | | | | | | | |

For the target property test and the feed resistance test, different straightening apparatuses 1 were used in Examples 1 to 4 and Comparative Examples 1 to 9. In Comparative Example 10, the straightening apparatus 1 was not used. In the straightening apparatuses 1, the positions of the plurality of straightening rollers 12 are adjusted so that the diameter t of the welding wire W, the radius r of each roller 12, the arrangement interval L between the rollers 12, the interaxial distance Lₐₗₗ between the first and nth rollers, the entrance wire deformation parameter Cᵢₙ, the exit wire deformation parameter Cₒᵤₜ, and the welding-wire-feed resistance parameter F have various values.

As the welding wire W, a solid wire with a diameter t of 1.2 mm was used.

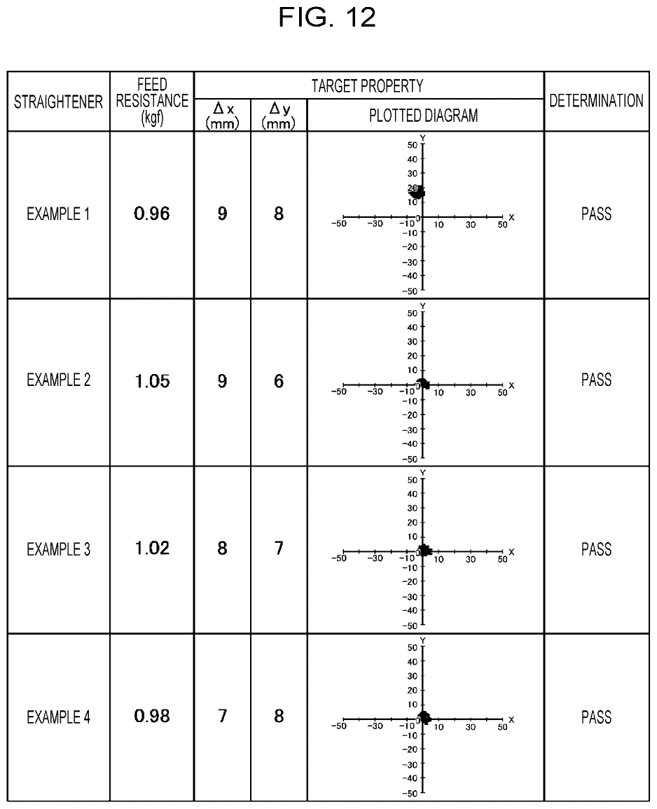

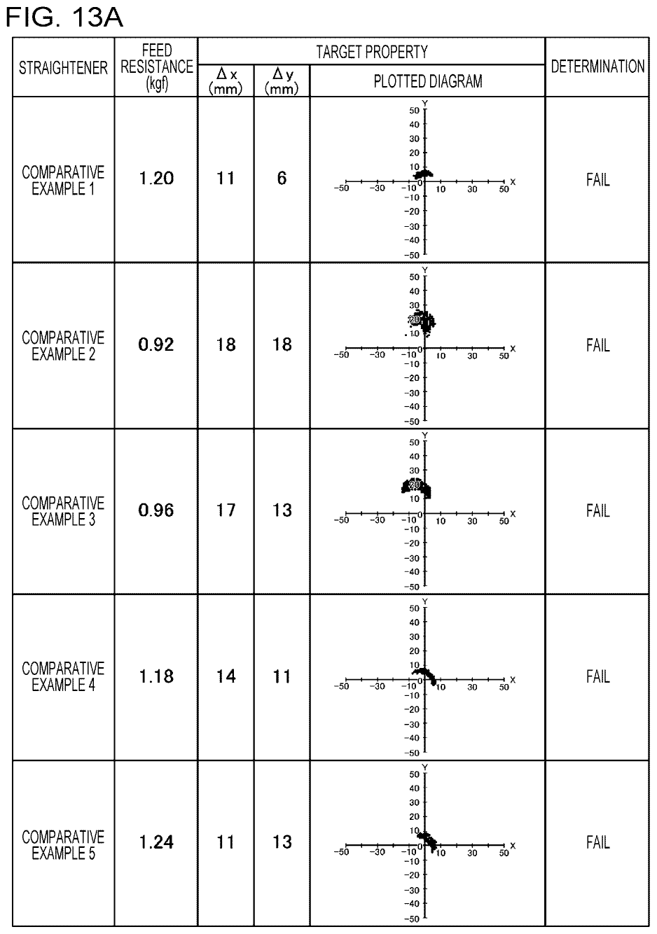

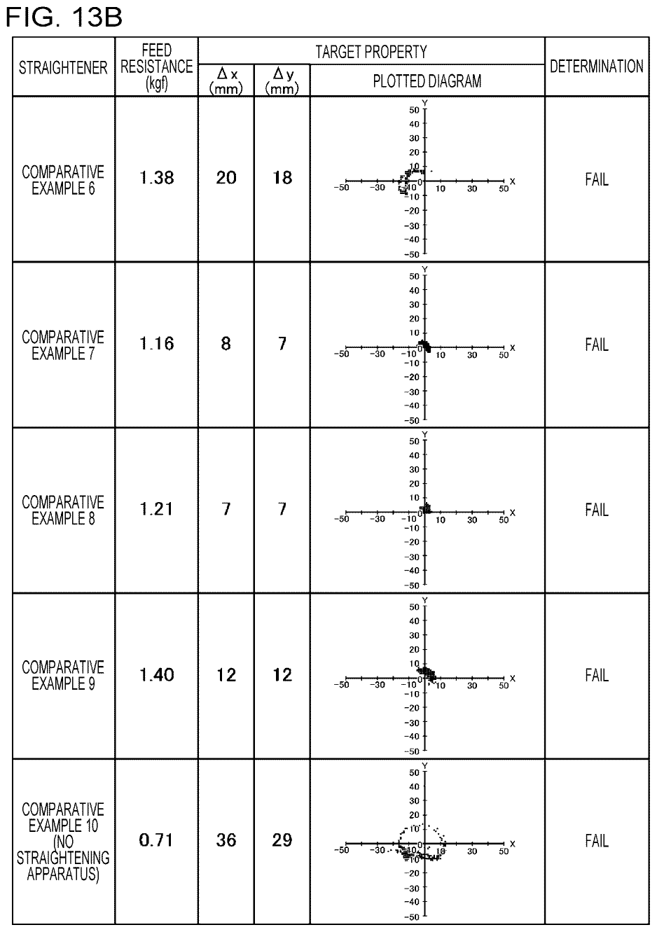

FIG. 12 is a table showing the test results regarding the target property and the feed resistance in Examples 1 to 4. FIGS. 13A and 13B are tables showing the test results regarding the target property and the feed resistance in Comparative Examples 1 to 10. FIGS. 12, 13A and 13B are diagrams obtained by plotting the position of the welding wire W in XY coordinates. For pass/fail determination of the target property of the welding wire W, the target property is determined to be favorable when Δx (mm), the difference between a maximum value and a minimum value in the X-direction, and Δy (mm), the difference between a maximum value and a minimum value in the Y-direction, are both less than or equal to 15 mm (Δx≤15 mm and Δy≤15 mm) in a plotted diagram, otherwise, the target property is determined to be unfavorable.

FIGS. 12, 13A and 13B also show the feed resistance of the welding wire W measured by the load cell of the feeding device 4. When the feed resistance is less than or equal to 1.15 kgf, the target property is determined to be favorable; otherwise, the target property is determined to be unfavorable.

In FIGS. 12, 13A and 13B, when Δx and Δy are both less than or equal to 15 mm and the feed resistance is less than or equal to 1.15 kgf, it is determined that improvement of the wire target property and reduction of the wire-feed resistance feed resistance are both achieved, and “DETERMINATION: PASS” is written; otherwise, “DETERMINATION: FAIL” is written.

As illustrated in Table 1, in Examples 1 to 4, the radius r of each roller 12, the arrangement interval L between the rollers 12, the interaxial distance Lan between the first and nth rollers, the entrance wire deformation parameter Cᵢₙ, the exit wire deformation parameter Cₒᵤₜ, and the welding-wire-feed resistance parameter F were all in the above-mentioned desirable ranges {5.0≤r<7.0 (mm), 5.0<L≤8.75 (mm), 20<Lₐₗₗ≤35 (mm), 1150≤Cᵢₙ≤1500, 4300≤Cₒᵤₜ≤49000, F<0.037}. Since the total length N of the first roller group 13a and the second roller group 13b of the straightening apparatuses 1 is less than or equal to 110 mm, miniaturization of the apparatus is also implemented. In these Examples 1 to 4, Δx≤15 mm and Δy≤15 mm, thus the target property of the welding wire W was favorable, and at the same time, the feed resistance was less than or equal to 1.15 kgf which was favorable. It has become clear that by setting the entrance wire deformation parameter Cᵢₙ, the exit wire deformation parameter Cₒᵤₜ, and the welding-wire-feed resistance parameter F in appropriate ranges in this manner, improvement of the wire target property, reduction of the wire-feed resistance, and miniaturization of the straightening apparatus can be achieved.

In contrast, in Comparative Example 10, because the straightening apparatus 1 was not used and curl of the welding wire W was not straightened, both Δx and Δy had values exceeding 15 mm by a large margin, and the target property of the welding wire W was poor. Because the straightening apparatus 1 was not used, the feed resistance was 0.71 kgf which was low.

In Comparative Example 1, the radius r of each roller 12, the arrangement interval L between the rollers 12, and the interaxial distance Lan between the first and nth rollers were out of the above-mentioned desirable ranges {5.0≤r<7.0 (mm), 5.0<L≤8.75 (mm), 20<Lₐₗₗ≤35 (mm)}. Therefore, the straightening apparatus increased in size. Although the entrance wire deformation parameter Cᵢₙ, and the exit wire deformation parameter Cₒᵤₜ were within the desirable ranges {1150≤Cᵢₙ≤1500, 4300≤Cₒᵤₜ≤49000}, the welding-wire-feed resistance parameter F was out of the desirable range (F<0.037). Therefore, Δx≤15 mm and Δy≤15 mm, thus the target property of the wire is secured, whereas the wire-feed resistance increased, and exceeded 1.15 kgf.

In Comparative Examples 2 to 9, the radius r of each roller 12, the arrangement interval L between the rollers 12, and the interaxial distance Lan between the first and nth rollers were within the above-mentioned desirable ranges {5.0≤r<7.0 (mm), 5.0<L≤8.75 (mm), 20<Lₐₗₗ≤35 (mm)}, thus the straightening apparatus was miniaturized.

However, in none of Comparative Examples 2 to 9, the entrance wire deformation parameter Cᵢₙ, the exit wire deformation parameter Cₒᵤₜ, and the welding-wire-feed resistance parameter F were all within the desirable ranges {1150≤Cᵢₙ≤1500, 4300≤Cₒᵤₜ≤49000, F<0.037}, thus a favorable target property of the welding wire and reduction of the wire-feed resistance were not achieved at the same time.

Specifically, in Comparative Examples 4, 5, 7, 8, 9, although the entrance wire deformation parameter Cᵢₙ, the exit wire deformation parameter Cₒᵤₜ were within the desirable ranges {1150≤Cᵢₙ≤1500, 4300≤Cₒᵤₜ≤49000}, the welding-wire-feed resistance parameter F was out of the desirable range {F<0.037}. Therefore, the target property of the wire was favorable, whereas the wire-feed resistance increased, and exceeded 1.15 kgf.

In Comparative Examples 2, 3, although the welding-wire-feed resistance parameter F was within the desirable range {F<0.037}, the entrance wire deformation parameter Cᵢₙ was out of the desirable range {1150≤Cᵢₙ≤1500}. Therefore, the wire-feed resistance was reduced to 1.15 kgf of less, whereas Δx and Δy both exceeded 15 mm, thus the target property of the wire deteriorated.

In Comparative Example 6, the entrance wire deformation parameter Cᵢₙ, the exit wire deformation parameter Cₒᵤₜ, and the welding-wire-feed resistance parameter F were all out of the desirable ranges, the wire-feed resistance exceeded 1.15 kgf, Δx and Δy both exceeded 15 mm, thus the target property of the wire deteriorated, and the wire-feed resistance increased.

Meanwhile, the embodiments disclosed this time are exemplifications in all respects, and are not considered to be restrictive. Particularly, in the embodiments disclosed this time, the matters that are not explicitly disclosed, for example, operating conditions and measurement conditions, various parameters, and the dimensions, weight, volume of components do not depart from the scope normally practiced by those skilled in the art, and values which may occur to those ordinary skilled in the art are used.

For example, the first roller group 13a is disposed via the first base 14a, and the second roller group 13b is disposed via the second base 14b. However, for example, regarding the first roller group 13a, even if the first base 14a is not used, the first roller group 13a can be disposed at the above-mentioned position with respect to the straightening path T by forming bolt holes in the frame 10, and directly screwing the bolts B into the bolt holes with a sufficiently increased length of the spacers S.

As described above, the following matters are disclosed in the present specification.
(1) A welding-wire-straightening apparatus for straightening bend of a welding wire, comprising two roller groups each including a plurality of straightening rollers, the welding wire being passed through the two roller groups,
wherein the plurality of straightening rollers included in each of the roller groups are arranged with a predetermined arrangement interval L in a passing direction of the welding wire so as to be opposed across a straightening path along which the welding wire is passed,
the two roller groups are arranged so that opposing directions across the straightening path are different,
in each of the roller groups, the plurality of straightening rollers are such that a first roller, a second roller, . . . , nth roller are sequentially disposed in the passing direction of the welding wire, bending deformation in opposite directions is alternately applied to the welding wire by these n rollers (n is an integer greater than or equal to 4) to straighten curl,
let t (mm) be a diameter of the welding wire,
let δᵢₙ (mm) be an entrance roller engaging amount caused by the first roller, the second roller and the third roller,
let 2Lᵢₙ (mm) be an interaxial distance between the first roller and the third roller,
let gᵢₙ (mm) be an entrance chord length which is a chord length of an overlapping portion of the second roller with the welding wire under an assumption that the welding wire is linearly arranged to come into contact with the first roller and the third roller,
let δₒᵤₜ (mm) be an exit roller engaging amount caused by the (n−2)th roller, the (n−1)th roller and the nth roller,
let 2Lₒᵤₜ (mm) be an interaxial distance between the nth roller and the (n−2)th roller,
let gₒᵤₜ (mm) be an exit chord length which is a chord length of an overlapping portion of the (n−1)th roller with the welding wire under an assumption that the welding wire is linearly arranged to come into contact with the (n−2)th roller and the nth roller, then
the n straightening rollers are positioned so that an entrance wire deformation parameter Cᵢₙ calculated by a mathematical expression Cᵢₙ=Lᵢₙ/[{(δᵢₙ+t)/gᵢₙ}²] is 1150 to 1500, and an exit wire deformation parameter Cₒᵤₜ calculated by a mathematical expression Cₒᵤₜ=Lₒᵤₜ/[{(Sout+t)/gₒᵤₜ}²] is 4300 to 49000, and
the n straightening rollers are positioned so that a welding-wire-feed resistance parameter F calculated by a mathematical expression F=(Lᵢₙ/Cᵢₙ+Lₒᵤₜ/Cₒᵤₜ)×n is less than 0.037.

According to (1), it is possible to provide a welding-wire-straightening apparatus that can achieve improvement of the wire target property, reduction of the wire-feed resistance, and miniaturization of the straightening apparatus.

(2) The welding-wire-straightening apparatus according to (1),
wherein a radius r of the straightening rollers is less than 7 mm.

According to (2), the wire deformation parameter can have a favorable numerical value while miniaturizing the straightening apparatus.

(3) The welding-wire-straightening apparatus according to (1) or (2),
wherein a radius r of the straightening rollers is greater than or equal to 5 mm.

According to (3), the wire deformation parameter can have a favorable numerical value while miniaturizing the straightening apparatus.

(4) The welding-wire-straightening apparatus according to any one of (1) to (3),
wherein an arrangement interval L between the plurality of straightening rollers is less than or equal to 8.75 mm.

According to (4), the wire deformation parameter can have a favorable numerical value while miniaturizing the straightening apparatus.

(5) The welding-wire-straightening apparatus according to any one of (1) to (4),
wherein an arrangement interval L between the plurality of straightening rollers is greater than 5 mm.

According to (5), the wire deformation parameter can have a favorable numerical value while miniaturizing the straightening apparatus.

(6) The welding-wire-straightening apparatus according to any one of (1) to (5),
wherein an interaxial distance Lan between the first roller and the nth roller is less than or equal to 35 mm.

According to (6), the wire deformation parameter can have a favorable numerical value while miniaturizing the straightening apparatus.

(7) The welding-wire-straightening apparatus according to any one of (1) to (6),
wherein an interaxial distance Lan between the first roller and the nth roller is greater than 20 mm.

According to (7), the wire deformation parameter can have a favorable numerical value while miniaturizing the straightening apparatus.

(8) The welding-wire-straightening apparatus according to any one of (1) to (7),
wherein the welding wire is a solid wire.

According to (8), the welding wire can be favorably used to straighten the curl and twist of the solid wire.

(9) The welding-wire-straightening apparatus according to any one of (1) to (8),
wherein the n=5.

According to (9), the welding-wire-straightening apparatus can be miniaturized while stabilizing the target property of the welding wire.

(10) The welding-wire-straightening apparatus according to any one of (1) to (8),
wherein a total length N of the roller groups is greater than 60 mm, and less than or equal to 110 mm.

According to (10), the straightening apparatus is unlikely to be restricted by the size and shape of the installation space, and when the straightening apparatus is provided on the robot arm, the range of motion of the welding robot can be made wider.

Although various embodiments have been described above with reference to the drawings, needless to say that the present invention is not limited to such examples. It is apparent that various modification examples and alteration examples will occur to those skilled in the art within the scope described in the appended claims, and it should be understood that those examples naturally fall within the technical scope of the present invention. In a range not departing from the spirit of the invention, the components in the above embodiments may be combined in any manner.

The present application is based on Japanese Patent Application (No. 2023-050267) filed on Mar. 27, 2023, the entire contents of which are incorporated herein by reference.

### REFERENCE SIGNS LIST

1 welding-wire-straightening apparatus
2 welding robot
3 pack
4 feeding device
5, 6 conduit cable
7 welding torch
8 contact chip
10 frame
11a, 11b guide pipe
12 straightening roller
12a first roller
12b second roller
12c third roller
12d fourth roller
12e fifth roller
13a first roller group
13b second roller group
14a first base
14b second base
15a, 15b wall plate
20 welding torch
A1, A2 support surface
B bolt
C wire deformation parameter
Cᵢₙ entrance wire deformation parameter
Cₒᵤₜ exit wire deformation parameter
F welding-wire-feed resistance parameter
G straightening groove
Gb groove bottom
Gu upper end
GL opening width
gᵢₙ entrance chord length
gₒᵤₜ exit chord length
L arrangement interval
2Lᵢₙ interaxial distance between first roller and third roller
2Lₒᵤₜ interaxial distance between nth roller and (n−2)th roller
Lₐ₁₁ interaxial distance between first roller and nth roller
M total length of straightening apparatus
N total length of first roller group and second roller group
r radius of straightening roller
2r diameter of straightening roller
P1, P2, P3 position
S spacer
T straightening path
t diameter of welding wire
W flux-cored welding wire (welding wire)
δᵢₙ entrance roller engaging amount
δₒᵤₜ exit roller engaging amount
(δ+t) push-in amount

1. A welding-wire-straightening apparatus for straightening bend of a welding wire, comprising two roller groups each including a plurality of straightening rollers, the welding wire being passed through the two roller groups,
wherein the plurality of straightening rollers included in each of the roller groups are arranged with a predetermined arrangement interval L in a passing direction of the welding wire so as to be opposed across a straightening path along which the welding wire is passed,
the two roller groups are arranged so that opposing directions across the straightening path are different,
in each of the roller groups, the plurality of straightening rollers are such that a first roller, a second roller, . . . , nth roller are sequentially disposed in the passing direction of the welding wire, bending deformation in opposite directions is alternately applied to the welding wire by these n rollers (n is an integer greater than or equal to 4) to straighten curl,
let t (mm) be a diameter of the welding wire,
let δᵢₙ (mm) be an entrance roller engaging amount caused by the first roller, the second roller and the third roller,
let 2Lᵢₙ (mm) be an interaxial distance between the first roller and the third roller,
let gᵢₙ (mm) be an entrance chord length which is a chord length of an overlapping portion of the second roller with the welding wire under an assumption that the welding wire is linearly arranged to come into contact with the first roller and the third roller,
let δₒᵤₜ (mm) be an exit roller engaging amount caused by the (n−2)th roller, the (n−1)th roller and the nth roller,
let 2Lₒᵤₜ (mm) be an interaxial distance between the nth roller and the (n−2)th roller,
let gₒᵤₜ (mm) be an exit chord length which is a chord length of an overlapping portion of the (n−1)th roller with the welding wire under an assumption that the welding wire is linearly arranged to come into contact with the (n−2)th roller and the nth roller, then
the n straightening rollers are positioned so that an entrance wire deformation parameter Cᵢₙ calculated by a mathematical expression Cᵢₙ=Lᵢₙ/[{(δᵢₙ+t)/gᵢₙ}²] is 1150 to 1500, and an exit wire deformation parameter Cₒᵤₜ calculated by a mathematical expression Cₒᵤₜ=Lₒᵤₜ/[{(Sout+t)/gₒᵤₜ}²] is 4300 to 49000, and
the n straightening rollers are positioned so that a welding-wire-feed resistance parameter F calculated by a mathematical expression F=(Lᵢₙ/Cᵢₙ+Lₒᵤₜ/Cₒᵤₜ)×n is less than 0.037.

2. The welding-wire-straightening apparatus according to claim 1,
wherein a radius r of the straightening rollers is less than 7 mm.

3. The welding-wire-straightening apparatus according to claim 1,
wherein a radius r of the straightening rollers is greater than or equal to 5 mm.

4. The welding-wire-straightening apparatus according to claim 1,
wherein an arrangement interval L between the plurality of straightening rollers is less than or equal to 8.75 mm.

5. The welding-wire-straightening apparatus according to claim 1,
wherein an arrangement interval L between the plurality of straightening rollers is greater than 5 mm.

6. The welding-wire-straightening apparatus according to claim 1,
wherein an interaxial distance Lan between the first roller and the nth roller is less than or equal to 35 mm.

7. The welding-wire-straightening apparatus according to claim 1,
wherein an interaxial distance Lan between the first roller and the nth roller is greater than 20 mm.

8. The welding-wire-straightening apparatus according to claim 1,
wherein the welding wire is a solid wire.

9. The welding-wire-straightening apparatus according to claim 1,
wherein the n=5.

10. The welding-wire-straightening apparatus according to claim 1,
wherein a total length N of the roller groups is greater than 60 mm, and less than or equal to 110 mm.
